(19) United States
(12) Patent Application Publication
(10) Pub. No.: US 2008/0149137 A1
(43) Pub. Date: Jun. 26, 2008

(54) Method For Cleaning Surfaces

(75) Inventors: Ulrich Steinbrenner, Neustadt (DE); Christof Mock, Mannheim (DE); Gunnar Schornick, Neuleiningen (DE); Stefan Frenzel, Mannheim (DE); Moritz Ehrenstein, Ludwigshafen (DE); Andreas Fechtenkotter, Ludwigshafen (DE); Antje Ziemer, Mannheim (DE); Kathrin Michl, Ludwigshafen (DE); Christian Hubert Weidl, Mannheim (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/814,577

(22) PCT Filed: Jan. 19, 2006
(86) PCT No.: PCT/EP2006/050321

§ 371 Date: Jul. 24, 2007

(30) Foreign Application Priority Data
Jan. 24, 2005 (DE) 10 2005 003 308.3
May 19, 2005 (DE) 10 2005 023 801.7
Jun. 24, 2005 (DE) 10 2005 029 745.5

(51) Int. Cl. B08B 1/00; B08B 9/08; B32B 5/18; B05D 3/00

(52) U.S. Cl. 134/8; 134/6; 428/159; 427/393.5

(57) ABSTRACT

A method for cleaning surfaces using aminoplast foam pieces produced from
(a) open-cell aminoplast foams having a density in the range from 5 to 500 kg/m³ and a mean pore diameter in the range from 1 μm to 1 mm or
(b) open-cell aminoplast foams having a density in the range from 5 to 500 kg/m³ and a mean pore diameter in the range from 1 μm to 1 mm, which have been treated
(b1) with an aqueous formulation of at least one compound (b-1) having at least one hemiaminal or aminal group per molecule or at least one copolymer which comprises, incorporated in the form of polymerized units, at least one comonomer containing OH groups or β-dicarbonyl groups or epoxide groups, or
(b2) with at least one polymer (c-1) which is solid at room temperature, contains carboxyl groups and/or carboxylic ester groups and has a molecular weight Mₙ in the range from 1000 to 1 000 000 g/mol,
   the aminoplast foam pieces used having an average diameter in the range from 0.1 mm to 50 mm.

The present invention relates to a method for cleaning surfaces using aminoplast foam pieces produced from
(a) open-cell aminoplast foams having a density in the range from 5 to 500 kg/m³ and a mean pore diameter in the range from 1 μm to 1 mm or
(b) open-cell aminoplast foams having a density in the range from 5 to 500 kg/m³ and a mean pore diameter in the range from 1 μm to 1 mm, which have been treated
(b1) with an aqueous formulation of at least one compound (b-1) having at least one hemiaminal or aminal group per molecule or at least one copolymer which comprises, incorporated in the form of polymerized units, at least one comonomer containing OH groups or β-dicarbonyl groups or epoxide groups, or
(b2) with at least one polymer (b-2) which is solid at room temperature, contains carboxyl groups and/or carboxylic ester groups and has a molecular weight Mₙ) in the range from 1000 to 1 000 000 g/mol,
   the aminoplast foam pieces used having an average diameter in the range from 0.1 mm to 50 mm,

The present invention furthermore relates to aminoplast foam pieces produced from
(a) open-cell aminoplast foams having a density in the range from 5 to 500 kg/m³ and a mean pore diameter in the range from 1 μm to 1 mm or
(b) open-cell aminoplast foams having a density in the range from 5 to 500 kg/m³ and a mean pore diameter in the range from 1 μm to 1 mm, which have been treated
(b1) with an aqueous formulation of at least one compound (b-1) having at least one hemiaminal or aminal group per molecule or at least one copolymer which comprises, incorporated in the form of polymerized units, at least one comonomer containing OH groups or β-dicarbonyl groups or epoxide groups, or
(b2) with at least one polymer (b-2) which is solid at room temperature, contains carboxyl groups and/or carboxylic ester groups and has a molecular weight Mₙ in the range from 1 000 to 1 000 000 g/mol,
   the aminoplast foam pieces used having an average diameter in the range from 0.1 mm to 50 mm,

The present invention further relates to the use of aminoplast foam pieces according to the invention.

Poorly accessible surfaces, for example inner surfaces of apparatuses, are difficult to clean mechanically without damaging them. In many cases, the relevant apparatus has to be dismantled and then cleaned, which always involves costs and, particularly in the case of commercially used apparatuses, down times. Immersing apparatuses in solvents or cleaning agents can result in seals being attacked and may not be feasible if the apparatus to be cleaned is large. Furthermore, not all impurities can be thoroughly removed in solvents. It is often observed that either large amounts of solvent are required or that a fine film of the relevant impurity remains on the surface to be cleaned. In poorly accessible areas, it is even possible for relatively large amounts of impurity to remain on the surface to be cleaned. The use of strong abrasives, such as, for example, steel wool or emery, can cause mechanical damage to the surface to be cleaned and hence, for example, to the apparatus to be cleaned.

It was therefore the object to provide a method with the aid of which it is possible to clean in particular poorly accessible surfaces without mechanical damage to the relevant surface occurring.

It was furthermore the object to provide assistants with the aid of which poorly accessible surfaces can be cleaned.

Accordingly, the method defined at the outset was found.

The method defined at the outset is a method for cleaning surfaces. Surfaces in the context of the present invention may be flat or curved. Surfaces in the context of the present invention may be smooth, i.e. unstructured, or structured. Structured surfaces in the context of the present invention may have, at regular or irregular distances, elevations and/or depressions which in each case may have the same shape or, preferably, a different shape. Said elevations and/or depressions may have any desired shape, polygonal or round elevations, furrows, burrs, grooves, pores, teeth, points and cutting edges being preferred.

In an embodiment of the present invention, said elevations or depressions may have an average spacing in the range from 100 nm to 1 cm, preferably from 1 μm to 1 mm, and an average height or depth in the range from 100 nm to 5 mm, preferably from 1 μm to 5 mm.

The spacing and the height or depth of said elevations or depressions can be determined by methods known per se, for example by microscopy, laser reflectometry and in particular stylus methods. The spacing of said elevations or depressions is determined, for example, by determining the average spacing of the average height.

In the context of the present invention, height or depth and spacing of said elevations or depressions are preferably defined as follows: a local maximum (maximum 1) is chosen on the structured surface to be cleaned. Starting from maximum 1 as the midpoint, concentric circles are followed away from maximum 1, and further local maxima are detected, for example maximum 2. Conceptually, the structured surface to be cleaned is now intersected by planes a which comprise maximum 1 and maximum 2 and are approximately perpendicular to a surface of fit relating to the structured surface to be cleaned. The latter is defined by stating that the respective plane a is approximately perpendicular to further planes b which include maxima which are remote relative to the distance between maximum 1 and maximum 2 (about 100 times the spacing of the respective maxima) and are associated with the structured surface to be cleaned. By intersecting the structured surface to be cleaned with the planes a, curves which run from maximum 1 to maximum 2 are obtained. It is now necessary to find the minimum (1,2) located in between and the height and distance of the maxima 1 and 2. A straight line g(1,2) is laid through maximum 1 and maximum 2, and the distance d(1,2) is obtained directly from the classical definition of distance in Euclidian geometry. That parallel p(1,2) to g(1,2) within plane a which touches the structured surface to be cleaned and has a maximum distance from g(1,2) is now sought. The point of contact is the minimum (1,2) and the average height h(1,2) of the maxima 1 and 2 is the distance between p(1,2) and g(1,2), determined by the classical methods of Euclidian geometry. In the context of this document, maximum 1 is a true maximum when there is at least one further maximum 2 so that h(1,2)>0.2×d(1,2), preferably h(1,2)>0.33×d(1,2), particularly preferably h(1,2)>0.5×d(1,2). Furthermore, h(1,2)>5 nm must be true in order reliably to exclude atomic structures. If no such maximum 2 is found, then maximum 1 should be considered to be “waviness”. For all maxima 1 and in turn all maxima 2 belonging to it and for which the abovementioned condition applies, the average height and the average spacing can now be calculated from the associated h(1,2) and d(1,2) by length-weighted averaging, as follows: h(average)=sum over all maxima 1 and 2 of (h(1,2))²/sum over all maxima 1 and 2 of h(1,2) and d(average)=sum over all maxima 1 and 2 of (d(1,2))²/sum over all maxima 1 and 2 of d(1,2).

If the structured surfaces to be cleaned have elevations, the elevations may consist, for example, of the same material as the remaining surface. In another embodiment, the elevations consist of a material which differs from the remaining surface, emery paper and sandpaper being mentioned by way of example.

In an embodiment of the present invention, surfaces to be cleaned consist at least partly, preferably to an extent of more than 50%, of metals or alloys, such as, for example, iron, nickel chromium, aluminum, steel such as, for example, carbon steel but also Cr—V steel, Cr—V—Mo steel or Co steel copper, brass, tungsten carbide, cobalt, tungsten, titanium or zirconium.

In another embodiment of the present invention, surfaces to be cleaned consist of oxidic or ceramic materials, such as, for example, silicon dioxide, silicon dioxide, silicon carbide, silicon nitride, boron carbide, boron nitride, aluminum oxide, magnesium oxide, titanium oxide, zirconium oxide, mixed silicates, spinels or diamond, which in each case may be present in crystallized form, in amorphous form or as glass. Particular forms of oxidic materials may be, for example, structured stones, concrete, ceramic, clay, porcelain, grinding, cutting and roughing disks and grinding stones.

In another embodiment of the present invention, surfaces to be cleaned consist of organic polymers, for example thermosetting plastics or thermoplastics. Polystyrene, polypropylene, polyester, polyamide, polyoxymethylene (POM), polyethylene, polyacrylonitrile, polymethacrylate and copolymers, such as, for example, acrylonitrile/butadiene/styrene, may be mentioned by way of example.

In an embodiment of the present invention, structured surfaces are those surfaces which have been provided with a structure by sand blasting or shot blasting, embossing or lithographic structuring.

In a preferred embodiment of the present invention, surfaces to be cleaned are poorly accessible surfaces, i.e. for example those surfaces which cannot be reached with the hand. Preferred examples are inner surfaces of apparatuses, containers or tools, in particular inner surfaces of reaction vessels, kneading tools, gears, engines, stirrers and ball bearings. Further preferred examples are inner surfaces of pipes, for example pipelines or in pumps.

In another embodiment of the present invention, surfaces, such as, for example, wallpapers, ceramic, such as, for example, tiles or wash basins or bath tubs, floors, for example of laminate or linoleum or parquet, furniture, such as, for example, table tops or kitchen fronts, are cleaned. Surfaces of household appliances, such as, for example, electrical appliances, e.g. refrigerators, can also be thoroughly cleaned by the method according to the invention.

When carrying out the method according to the invention, structured or unstructured surfaces are cleaned to remove impurities comprising at least one substance which is selected from

fats, oils, waxes, for example polyethylene waxes, paraffin waxes, paraffin oils, ester oils, natural oils and fats, lubricating greases, bearing greases, Stauffer greases, montan waxes.
metal salts of anionic surfactants, such as, for example, lime soap,
biofilms, for example mold or Pseudomonas biofilms,
polymers, for example lacquer splashes, polyurethane foam, silicones polysiloxanes), metal oxides, for example copper oxide, lead oxide or nickel oxide, or rust formed by, for example, corrosion, or rust particles or rust film, in particular iron oxides, metal hydroxides and metal carbonates, which may be neutral acidic or basic, in particular iron, copper or nickel hydroxide, aluminum hydroxide magnesium oxide, MgCO₃, basic MgCO₃, CaCO₃, basic copper carbonate it being possible for metal oxides, metal carbonates and metal hydroxides to have been formed by corrosion from the parent metal of the structured surface for example of a tool or workplace, or to have been deposited in a secondary process,
residues of lubricants for example partially coked or partially or completely resinified lubricants and broken emulsions. The following may be mentioned by way of example: resinified natural ester oils on, for example, chain saws or coked oils on hotplates in polyester filament spinning mills
deposits and caking materials comprising, for example, cement or gypsum, customary household dirt such as house dust, also mixed with fats, fat from the kitchen area, also in resinified form, for example cooking fat or frying oil.

Other examples of impurities to be removed are inscriptions for example with ballpoint pen or felt tip pen.

Impurities may be distributed uniformly or nonuniformly over surfaces to be cleaned, for example in the form of spots, edges or splashes, or as a film.

For carrying out the method according to the invention, also referred to as cleaning method according to the invention in association with the present invention, it is possible, for example, to adopt a procedure in which a plurality of aminoplast foam pieces which have an average diameter in the range from 0.1 mm to 50 mm (weight average), preferably from 0.5 mm to 1 cm and particularly preferably from 1 mm to 5 mm, are used. The size of the aminoplast foam pieces used according to the invention and their size distribution can be determined by methods known per se, such as, for example, measurement of a sample of cleaning bodies, but also sieving methods or air classification.

Aminoplast foam pieces used according to the invention may have a broad or a narrow diameter distribution. If the quotient of mass average diameter and number average diameter is calculated, the quotient may be, for example, in the range from 1.1 to 10, preferably from 1.2 to 3.

Aminoplast foam pieces used according to the invention may have a regular or irregular shape. Examples of regular shapes are cubes cuboids, spheres and ellipsoids. Examples of irregular shapes are granules, shreds and shavings.

According to the invention, not only one aminoplast foam piece is used but a plurality thereof, preferably at least 10 particularly preferably at least 100 and very particularly preferably at least 500. The number of aminoplast foam pieces used matches the size and the form of the surface to be cleaned.

While the cleaning method according to the invention is being carried out, thorough mixing can be effected, for example by shaking stirring with, for example, one or more stirrers or pneumatic stirring, or by operating the relevant tool without substrates. Thus, it is preferable to load stirred vessels, stirrers, gears or kneading tools with a plurality of aminoplast foam pieces and then to switch them on.

For example, durations in the range from one minute to 48 hours, preferably from 5 minutes to 24 hours and particularly preferably from one to 10 hours can be chosen as the duration of the relevant cleaning method.

For carrying out the cleaning method according to the invention, a plurality of pieces of aminoplast foam in dry form or in a form moistened with, for example, water can be used.

After the cleaning according to the invention, residues of aminoplast foam pieces can be removed, for example, with compressed air or with the aid of an organic solvent or water, if required and desired.

Aminoplast foam pieces are used for carrying out the cleaning method according to the invention. Aminoplast foam pieces can be produced from
(a) open-cell aminoplast foams having a density in the range from 5 to 500 kg/m³ and a mean pore diameter in the range from 1 μm to 1 mm,
(b) open-cell aminoplast foams having a density in the range from 5 to 500 kg/m³ and a mean pore diameter in the range from 1 μm to 1 mm, which have been treated
(b1) with an aqueous formulation of at least one compound (b-1) having at least one hemiaminal or aminal group per molecule or at least one copolymer which comprises, incorporated in the form of polymerized units, at least one comonomer containing OH groups or β-dicarbonyl groups or epoxide groups, or
(b2) with at least one polymer (b-2) which is solid at room temperature, contains carboxyl groups and/or carboxylic ester groups and has a molecular weight Mₙ in the range from 1000 to 1 000 000 μmol.

At least one compound (b-1) is preferably a compound which was not used in the preparation of aminoplast foam (b).

In an embodiment of the present invention, open-cell aminoplast foams used according to the invention are those based on synthetic organic foam, for example comprising urea/formaldehyde resins, in particular aminoplast foams based on aminoplast/formaldehyde resins, in particular melamine/formaldehyde resins, aminoplast foams based on melamine/formaldehyde resins also being referred to as melamine foams.

The unmodified open-cell aminoplast foams (a) used for carrying out the method according to the invention are also referred to in the context of the present invention very generally as unmodified aminoplast foams (a). The unmodified open-cell aminoplast foams (a) used for carrying out the cleaning method according to the invention are described in more detail below.

For carrying out the method according to the invention, it is possible to start from open-cell aminoplast foams (a), in particular from aminoplast foams in which at least 50% of all lamellae are open, preferably from 60 to 100% and particularly preferably from 65 to 99.9%, determined according to DIN ISO 4590.

In an embodiment of the present invention, aminoplast foams (a) used according to the invention are rigid aminoplast foams, i.e., in the context of the present invention, aminoplast foams which have a compressive strength of 1 kPa or more at a compression of 40%, determined according to DIN 53577.

Aminoplast foams (a) used according to the invention have a density in the range from 5 to 500 kg/m³, preferably from 6 to 300 kg/m³ and particularly preferably in the range from 7 to 300 kg/m³.

Aminoplast foams (a) used according to the invention may have a mean pore diameter (number average in the range from 1 μm to 1 mm, preferably from 50 to 500 μm, determined by evaluation of micrographs of sections.

In an embodiment of the present invention, aminoplast foams (a) used according to the invention may have not more than 20, preferably not more than 15 and particularly preferably not more than 10 pores per m² which have a diameter in the range up to 20 μm. The remaining pores usually have a smaller diameter.

In an embodiment of the present invention, aminoplast foams (a) used according to the invention have a BET surface area in the range from 0.1 to 50 m²/g, preferably from 0.5 to 20 m²/g, determined according to DIN 66131.

In an embodiment of the present invention, aminoplast foams (a) used according to the invention have a sound absorption of more than 50%, measured according to DIN 52215, at a frequency of 2000 Hz and a layer thickness of the relevant foam (a) of 50 mm.

In a special embodiment of the present invention open-cell aminoplast foams (a) used according to the invention have a sound absorption of more than 0.5, measured according to DIN 52212, at a frequency of 2000 Hz and a layer thickness of the relevant foam (a) of 40 mm.

Open-cell aminoplast foams (a) used as starting materials may have any desired geometrical shapes, for example sheets, spheres, cylinders, powders, cubes, flakes, cuboids, saddle elements, rods or round, rectangular or square columns and preferably disks or conical or pin-like forms. The dimensions of aminoplast foams (a) used as starting materials are not critical, provided that they can be mechanically compressed on machines. Sheets, cylinders, cubes, cuboids or rectangular columns which can be mechanically compressed in conventional apparatuses are preferred, particularly preferably disks or conical or pin-like forms.

Melamine foams (a) particularly suitable as starting material for carrying out the method according to the invention are known as such. They are prepared, for example, by foaming
i) a melamine/formaldehyde precondensate which, in addition to formaldehyde, may comprise further carbonyl compounds, such as, for example, aldehydes, incorporated in the form of condensed units, in the presence of
ii) one or more blowing agents,
iii) if appropriate, one or more emulsifiers,
iv) one or more curing agents,

Melamine/formaldehyde precondensates i) may be unmodified but may also be modified; for example, up to 20 mol % of the melamine can be replaced by other thermosetting plastic precursors known per se, for example alkyl-substituted melamine, urea, urethane, carboxamides, dicyandiamide, guanidine, sulfurylamide, sulfonamides, aliphatic amines, phenol and phenol derivatives. In addition to formaldehyde, modified melamine/formaldehyde precondensates may comprise, incorporated in the form of condensed units, for example, acetaldehyde, trimethylolacetaldehyde, acrolein, furfurol, glyoxal, phthaldialdehyde and terephthaldialdehyde as further carbonyl compounds.

The following are suitable as blowing agents ii): water, inert gases, in particular carbon dioxide, and so-called physical blowing agents. Physical blowing agents are compounds which are inert to the components used, are preferably liquid at room temperature and evaporate under the conditions of the aminoplast formation. The boiling point of these compounds is preferably below 110° C., in particular below 80° C. The physical blowing agents also include inert gases, which are introduced into the components i) and ii) used or are dissolved in them, for example carbon dioxide, nitrogen or noble gases.

Suitable compounds which are liquid at room temperature are selected from the group comprising alkanes and/or cycloalkanes having at least 4 carbon atoms, dialkyl ethers, esters, ketones, acetals, fluoroalkanes having 1 to 8 carbon atoms and tetraalkylsilanes having 1 to 3 carbon atoms in the alkyl chain, in particular tetramethylsilane.

The following may be mentioned as examples: propane, n-butane, isobutane and cyclobutane, n-pentane, isopentane and cyclopentane, cyclohexane, dimethyl ether, methyl ethyl ether, methyl tert-butyl ether, methyl formate, acetone and fluorinated alkanes which can be degraded in the troposphere and therefore do not harm the ozone layer, such as trifluoromethane, difluoromethane, 1,1,1,3,3-pentafluorobutane, 1,1,1,3,3-pentafluoropropane, 1,1,1,2-tetrafluoroethane, 1,1,1-trifluoro-2,2,2-trichloroethane, 1,1,2-trifluoro-1,2,2-trichloroethane, difluoroethanes and heptafluoropropane. Said physical blowing agents can be used alone or in any desired combinations with one another.

The use of perfluoroalkanes for producing fine cells is disclosed in EP-A 0 351 614.

Emulsifiers iii) used may be conventional nonionogenic, anionic, cationic or betaine surfactants, in particular C₁₂-C₃₀-alkanesulfonates, preferably C₁₂-C₁₈-alkanesulfonates, and polyethoxylated C₁₀-C₂₀-alkyl alcohols, in particular of the formula R⁶—O (CH₂—CH₂—O)ₓ—H, where R⁶ is selected from C₁₀-C₂₀-alkyl and x may be, for example, an integer in the range from 5 to 100.

Particularly suitable curing agents iv) are acidic compounds, such as, for example, inorganic Brønsted acids, e.g. sulfuric acid or phosphoric acid, organic Brønsted acids, such as, for example, acetic acid or formic acid, Lewis acids and also so-called latent acids.

Examples of suitable melamine foams and processes for their preparation are to be found in EP-A 0 017 672.

Of course, aminoplast foams (a) used according to the invention may comprise additives and compounding materials which are customary in foam chemistry, for example antioxidants, flameproofing agents, fillers, colorants, such as, for example, pigments or dyes, and biocides, for example

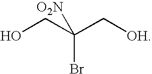

For carrying out the cleaning method according to the invention, it is possible to use either unmodified aminoplast foams (a), which are described above, or preferably so-called modified aminoplast foams (b), the preparation of which is described below.

Modified aminoplast foams (b) are prepared, for example, starting from one or more unmodified aminoplast foams (a) which can be prepared as described above. Before the cleaning method according to the invention is carried out, aminoplast foam (a) can be treated with
(b1) at least one compound having at least one hemiaminal or aminal group per molecule or at least one copolymer which comprises, incorporated in the form of polymerized units, at least one comonomer containing OH groups or β-dicarbonyl groups or epoxide groups or n-butyl acrylate, or
(b2) with at least one polymer (b-2) which is solid at room temperature, contains carboxyl groups and/or carboxylic ester groups and has a molecular weight Mₙ in the range from 1000 to 1 000 000 g/mol.

Below, compounds having at least one hemiaminal or aminal group per molecule and copolymers which comprise, incorporated in the form of polymerized units, at least one comonomer containing OH groups or β-dicarbonyl groups or epoxide groups, or n-butyl acrylate, are abbreviated to compound (b-1) or (b-1). Compound (b-1) is obtainable, for example, by condensation of at least one nitrogen-containing compound (B1) and at least one carbonyl compound (B2) and, if appropriate, further compounds (B3) and, if appropriate, further reactions after the condensation.

Treatment with (b-1) or (b-2) is preferably effected in the form of aqueous formulations. In the context of the present invention, an aqueous formulation may be an aqueous solution, emulsion or dispersion.

Examples of nitrogen-containing compounds (B1) are urea, N,N′-dimethylurea, triazones, tetrahydropyrimidinones, imidazolinones, tetrahydro-4H-1,3,5-oxadiazin-4-ones, alkyl carbamates, methoxyethyl carbamates and N-methylol(meth)acrylamide.

Examples of carbonyl compounds (B2) are

ketones, in particular di-(C₁-C₁₀-alkyl) ketones,
preferably mono-, di- and polyaldehydes, in particular C₁-C₁₀-alkylmonoaldehydes, such as, for example, acetaldehyde or propionaldehyde, and very particularly preferably formaldehyde, and furthermore dialdehydes, such as, for example, glyoxal or phthaldialdehyde, such as, for example, 1,2-phthaldialdehyde, butanedial, glutardialdehyde and hexane-1,6-dial.

Examples of particularly preferred further compounds (B3) are monohydric or trihydric alcohols, such as, for example, C₁-C₁₀-alkanols, in particular methanol, ethanol, n-propanol and n-butanol, furthermore ethylene glycol, propylene glycol, butylene glycol, 1,4-butanediol, 1,6-hexanediol, 1,12-dodecanediol, glycerol, diethylene glycol, dipropylene glycol, polyethylene glycols having on average up to 200, preferably from 3 to 20, ethylene oxide units per molecule (number average), polypropylene glycols having on average up to 200, preferably from 3 to 20, propylene oxide units per molecule (number average), polytetrahydrofuran having on average up to 200, preferably from 3 to 20, 1,4-butanediol units per molecule (number average) and mono-C₁-C₁₀-alkyl-endcapped mono-, di- or polyethylene or -propylene glycols having on average up to 200, preferably from 3 to 20, alkylene oxide units per molecule (number average).

Examples of further reactions after the condensation are esterifications, etherifications and free radical (co)polymerizations.

In an embodiment of the present invention, compound (b-1) may be prepared from at least one nitrogen-containing compound (B1), at least two carbonyl compounds (B2) and, for example, up to 3 different further compounds (B3).

Particularly preferred examples of compounds (b-1) are those of the general formulae I a to I b

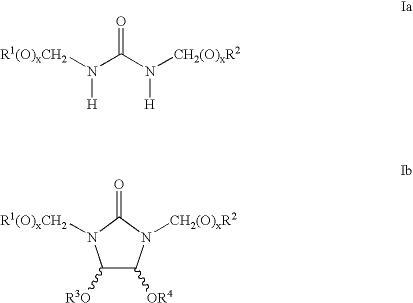

where the variables are defined as follows:
R¹ and R² are different or preferably identical and are selected from hydrogen,
   C₁-C₁₂-alkyl, branched or straight-chain, selected from methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl and n-dodecyl; preferably C₁-C₆alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl and sec-hexyl, particularly preferably C₁-C₄-alkyl, such as methyl, ethyl, n-propyl, isopropyl, n-butyl, isobutyl, sec-butyl and ter-butyl,
   (—CH₂—CH₂—O)ₘ—R⁵, (—CHCH₃—CH₂—O)ₘ—R⁵, (—CH₂—CHCH₃O)ₘR⁵,
   (—CH₂—CH₂—CH₂—O)ₘ—R⁵, (—CH₂—CH₂—CH₂—CH₂—O)ₘ—R⁵,
x are identical or different and are an integer selected from zero and one, at least one x being chosen to be equal to one in formula I a; in formula I b, both x may be chosen to be zero,
m is an integer in the range from 1 to 20,
R³ and R⁴ are different or preferably identical and are selected from hydrogen,
C₁-C₁₂-alkyl, branched or straight-chain, selected from methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl and n-dodecyl; preferably C₁-C₆-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl and sec-hexyl, particularly preferably C₁-C₄-alkyl, such as methyl, ethyl, n-propyl, isopropyl, n-butyl, isobutyl, sec-butyl and tert-butyl, or together are C₂-C₄-alkylene, such as, for example, —CH₂—CH₂—, —(CH₂)₃— or —(CH₂)₄—,
R⁵ are identical or different and are selected from C₁-C₄-alkyl, such as methyl, ethyl, n-propyl, isopropyl, n-butyl, isobutyl, sec-butyl and tert-butyl
   and in particular hydrogen.

Compounds (b-1), in particular of the general formulae I a and I b, are known per se. Compounds (b-1), in particular of the general formulae I a and I b, are in general not present in pure form according to a defined formula; usually, intermolecular rearrangements of the radicals R¹ to R⁴, i.e. for example transaminalization reactions, and, to a certain degree, also condensation reactions and elimination reactions are observed. The abovementioned formula I a or I b is to be understood in the sense that it defines the stoichiometric ratios of the substituents and also includes intermolecular rearrangement products and condensates.

Another group of preferably used compounds (b-1) are homopolymers and in particular copolymers of compounds of the general formula II

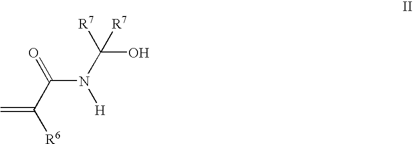

where the variables are defined as follows:
R⁶ is selected from hydrogen and C₁-C₁₂-alkyl, preferably linear C₁-C₁₂-alkyl, selected from methyl, ethyl, n-propyl, n-butyl, n-pentyl, n-hexyl, n-heptyl, n-octyl, n-nonyl, n-decyl and n-dodecyl; preferably linear C₁-C₆-alkyl, such as methyl, ethyl, n-propyl, n-butyl, n-pentyl, isopentyl and n-hexyl, particularly preferably C₁-C₄-alkyl, such as methyl, ethyl, n-propyl and n-butyl, hydrogen and methyl being very particularly preferred,
R⁷ are different or preferably identical and are selected from C₁-C₁₂-alkyl, preferably linear C₁-C₁₂-alkyl, selected from methyl, ethyl, n-propyl, n-butyl, n-pentyl, n-hexyl, n-heptyl, n-octyl, n-nonyl, n-decyl and n-dodecyl; preferably linear C₁-C₆-alkyl, such as methyl, ethyl, n-propyl, n-butyl, n-pentyl, isopentyl and n-hexyl, particularly preferably C₁-C₄-alkyl, such as methyl, ethyl, n-propyl and n-butyl,
   and particularly preferably hydrogen.

In formula II, very particularly preferably both variables R⁷ are hydrogen and R⁶ is selected from methyl and hydrogen.

Preferably used homopolymers and copolymers of compounds of the general formula II may have, for example, molecular weights M_{w} in the range from 10 000 to 250 000 g/mol, preferably from 20 000 to 240 000 g/mol.

If it is desired to use copolymers of one or more compounds of the general formula II, particularly suitable copolymers are those of one or more compounds of the general formula II with one comonomer or preferably at least two comonomers selected from one or more C₁-C₁₀-alkyl (meth)acrylates, in particular with methyl acrylate, ethyl acrylate, n-butyl (meth)acrylate, 2-ethylhexyl (meth)acrylate,

(meth)acrylic acid,
vinylaromatic compounds, such as, for example, styrene,
(meth)acrylonitrile and
(meth)acrylamide.

If it is desired to use copolymers which comprise, incorporated in the form of polymerized units, at least one comonomer containing OH groups or β-dicarbonyl groups or epoxide groups, or n-butyl acrylate, it is preferable to use copolymers which comprise, incorporated in the form of polymerized units, at least one comonomer of the general formula III

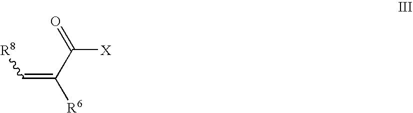

the variables being defined as follows.
R⁸ is selected from C₁-C₁₂-alkyl, preferably linear C₁-C₁₂-alkyl, selected from methyl, ethyl, n-propyl, n-butyl, n-pentyl, n-hexyl, n-heptyl, n-octyl, n-nonyl, n-decyl and n-dodecyl; preferably linear C₁-C₆-alkyl, such as methyl, ethyl, n-propyl, n-butyl, n-pentyl, isopentyl and n-hexyl, particularly preferably C₁-C₄-alkyl, such as methyl, ethyl, n-propyl and n-butyl,
   and very particularly preferably hydrogen,
X is selected from OH, glycidyl, 2-hydroxyethyl, 3-hydroxypropyl,

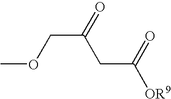

where
R⁹ is selected from C₁-C₁₂-alkyl, branched or straight-chain, selected from methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl and n-dodecyl, preferably C₁-C₆-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl and sec-hexyl, particularly preferably C₁-C₄-alkyl, such as methyl, ethyl, n-propyl, isopropyl, n-butyl, isobutyl, sec-butyl and tert-butyl, very particularly preferably methyl.

If it is desired to use as (b-1) those copolymers which comprise, incorporated in the form of polymerized units, a compound of the general formula III where X═OH, preferred copolymers are those which comprise no ethylene as a comonomer incorporated in the form of polymerized units.

In an embodiment of the present invention, copolymers chosen as (b-1) are those which contain, incorporated in the form of polymerized units:

up to 15% by weight, preferably from 0.5 to 10% by weight, of at least one comonomer of the general formula II or III,
from 0 to 80% by weight of n-butyl acrylate,
from 0 to 80% by weight of at least one further C₁-C₁₀-alkyl (meth)acrylate,
from 0 to 20% by weight, preferably from 0.1 to 15% by weight, of one or more further comonomers, such as, for example, (meth)acrylic acid, vinylaromatic compounds, such as, for example, styrene, (meth)acrylonitrile and (meth)acrylamide.

If it is desired to use copolymeric compounds of the general formula II or III it is preferable to use random copolymers which can be prepared by methods known per se, for example by emulsion polymerization.

In an embodiment of the present invention, aqueous formulations used for modifying aminoplast foam (b) comprise in the range from 1 to 60% by weight, preferably from 10 to 40% by weight, of compound (b-1).

Various techniques are conceivable for bringing aminoplast foams (b) into contact with compound (b-1).

Contact can be established, for example, by immersing aminoplast foam (b) in an aqueous formulation of compound (b-1) by impregnating aminoplast foam (b) with aqueous formulation of compound (b-1), by soaking unmodified foam (b) in aqueous formulation of compound (b-1), by incomplete or preferably complete spraying of aminoplast foam (b) with aqueous formulation of compound (b-1) or by application of aqueous formulation of compound (b-1) to aminoplast foam (b) by calendering.

In another embodiment of the present invention, a procedure is adopted in which aqueous formulation of compound (b-1) is applied to aminoplast foam (b) by knife coating. After soaking or application by knife coating or by calendering or spraying, it is possible to effect squeezing between at least two rolls, for example rotating rolls, for uniform distribution of the formulation and establishing of the desired concentration.

In an embodiment of the present invention, aminoplast foam (b) and aqueous formulation of compound (b-1) can be allowed to act on one another after having been brought into contact, for example over a period in the range from 0.1 second to 24 hours, preferably from 0.5 second to 10 hours, and particularly preferably from 1 second to 6 hours.

In an embodiment, aminoplast foam (b) aqueous formulation of compound (b-1) are brought into contact at temperatures in the range from 0° C. to 250° C., preferably from 5° C. to 190° C. and particularly preferably from 10 to 180° C.

In an embodiment, aminoplast foam (b) and aqueous formulation of compound (b-1) are initially brought into contact at temperatures in the range from 0° C. to 50° C., and the temperature is then changed, for example heating, to temperatures in the range from 60° C. to 250° C., preferably from 65° C. to 180° C., is effected.

In another embodiment, aminoplast foam (b) and aqueous formulation of compound (b-1) are initially brought into contact at temperatures in the range from 0° C. to 120° C., and the temperature is then changed, for example heating to temperatures in the range from 30° C. to 250° C., preferably from 125° C. to 200° C., is effected.

In a preferred embodiment of the present invention, the amounts of the starting materials, i.e. unmodified foam (a) and aqueous formulation of compound (b-1), are chosen so that the product according to the invention has a substantially higher density than the relevant unmodified foam (a).

In an embodiment of the present invention, atmospheric pressure is employed when bringing aminoplast foam (b) into contact with aqueous formulation of compound (b-1). In another embodiment, superatmospheric pressure is employed, for example pressures in the range from 1.1 bar to 10 bar. In another embodiment of the present invention, reduced pressure is employed, for example pressures in the range from 0.1 mbar to 900 mbar, preferably up to 100 mbar.

In an embodiment, aminoplast foam (b) is brought into contact with aqueous formulation of compound (b-1) so that compound (b-1) is distributed as uniformly as possible in all dimensions over aminoplast foam (b). Suitable methods are methods having a high application efficiency. The following may be mentioned by way of example: complete impregnation, immersion, flooding, treatment in a drum, spraying on, such as, for example, compressed-air spraying or airless spraying, and furthermore high-speed rotary atomization, coating, knife coating, calendering, spreading, application by means of a roller, wiping on, roll coating, spin coating and centrifuging.

In another embodiment, aminoplast foam (b) is brought into contact with aqueous formulation of compound (b-1) so that a nonuniform distribution of aqueous formulation of compound (b-1) on aminoplast foam (b) is produced. Thus, for example, aminoplast foam (b) can be sprayed nonuniformly with aqueous formulation of compound (b-1) and then allowed to act. In another embodiment, aminoplast foam (b can be soaked incompletely in aqueous formulation of compound (b-1). In another embodiment, a part of aminoplast foam (b) can be brought into contact once with aqueous formulation of compound (b-1) and another part of aminoplast foam (b) can be brought into contact a least twice with said formulation. In another embodiment, aminoplast foam (b) is completely impregnated with aqueous formulation of compound (b-1), and the uppermost layer is washed clean again with, for example, water. The time for action is then allowed. Consequently, aminoplast foam (b) is coated in the core; the outer surface remains uncoated.

If aminoplast foam (b) is brought into contact with aqueous formulation of compound (b-1) so that a nonuniform distribution of aqueous formulation of compound (b-1) on aminoplast foam (b) has been produced, it is possible, for example by allowing to act on one another over a period of 2 minutes or more, to ensure that not only the outermost layer of aminoplast foam (b) is brought into contact with aqueous formulation of compound (b-1).

If aminoplast foam (b) is brought into contact with aqueous formulation of compound (b-1) so that a nonuniform distribution of aqueous formulation of compound (b-1) on aminoplast foam (b) has been produced, modified foam may have nonuniform mechanical properties over its cross section. Thus, for example, it is possible for it to be softer in the areas where it has been brought into contact with larger proportions of aqueous formulation of compound (b-1) than in areas where it has been brought into contact with less aqueous formulation of compound (b-1).

In an embodiment, nonuniform distribution of the aqueous formulation of compound (b-1), which is undesirable per se in some cases, can be compensated by calendering on perforated rolls or perforated metal plates. The formation of a nonuniform distribution of aqueous formulation of compound (b-1) can be reduced by carrying out an extraction under reduced pressure on at least one perforated roll or at least one perforated plate, preferably at least two perforated rolls.

In a special embodiment, a defined liquor uptake, for example in the range from 20 to 800% by weight, based on the weight of the aminoplast foam (b), is established after contact has been effected by squeezing between two counterrotating rolls. The concentration of compound (b-1) in the formulation is from 1 to 99% by weight.

In an embodiment of the present invention, washing, for example with one or more solvents and preferably with water, can be carried out after contact has been effected.

In an embodiment of the present invention, bringing into contact and, if appropriate, washing can be followed by drying, for example mechanically by, for example, wringing out or calendering, in particular by squeezing by means of two rolls, or thermally, for example in microwave ovens, hot-air blowers or in drying ovens, in particular vacuum drying ovens, it being possible to operate drying ovens for example, at temperatures in the range from 30 to 150° C. In association with vacuum drying ovens under reduced pressure is understood as meaning a pressure of for example in the range from 0.1 to 850 mbar.

The time which is employed for any desired drying steps carried out is not by definition included in the action time.

In an embodiment, thermal drying can be effected by heating to temperatures in the range from 20° C. to 150° C., for example over a period of from 10 seconds to 20 hours.

In addition to the aqueous formulation of compound (b-1), according to the invention aminoplast foam (b) can be brought into contact with at least one catalyst (c-1). For example metal salts and ammonium salts and inorganic or organic acids are suitable. Suitable metal salts are, for example, metal halides, metal sulfates, metal nitrates, metal tetrafluoroborates, metal phosphates or mixtures thereof. Examples are magnesium chloride, magnesium sulfate, zinc chloride, lithium chloride, lithium bromide, boron trifluoride, aluminum chloride, aluminum sulfate, alums, such as, for example, KAI(SO₄)₂.12H₂O, zinc nitrate, sodium tetrafluoroborate and mixtures of the metal salts described above.

Ammonium salts suitable as the catalyst (c-1) are ammonium salts from the group consisting of ammonium chloride, ammonium nitrate, ammonium sulfate, ammonium oxalate, diammonium phosphate or mixtures of the ammonium salts described above.

Inorganic and organic acids suitable as catalyst (c-1) are maleic acid, formic acid, citric acid, tartaric acid, oxalic acid, p-toluenesulfonic acid, hydrochloric acid, sulfuric acid, boric acid and mixtures thereof.

Of course, it is also possible to use mixtures of, for example, at least one metal salt and at least one ammonium salt or at least one metal salt or ammonium salt and at least one organic or inorganic acid as catalyst (c-1).

Brønsted acid catalysts, for example ZnCl₂, Zn(NO3)₂, in each case in the form of their hydrates NH₄Cl, MgSO₄, Al₂(SO₄)₃, in each case in the form of their hydrates, and very particularly preferably MgCl₂, in particular in the form of its hexahydrate, are very particularly preferred as catalyst (c-1).

Based on compound (b-1), preferably a third to a twentieth of the weight of catalyst (c-1), determined in each case without any water of hydration present, is used.

Magnesium chloride, zinc chloride, magnesium sulfate and aluminum sulfate are preferably used. Magnesium chloride is particularly preferred.

In an embodiment, aminoplast foam (b) is brought into contact with aqueous solution of compound (b-1) and, if appropriate, catalyst (c-1) at a pH in the range from 3.0 to 7.5, it being possible to establish the desired pH, if appropriate, by addition of acid, alkali or a buffer. The use of a buffer is preferred.

In an embodiment, at east one aminoplast foam (b) can be brought into contact not only with aqueous formulation of compound (b-1) and, if appropriate, catalyst (c-1) but also with at least one compounding material (d-1) selected from

biocides, such as, for example, silver particles, or monomeric or polymeric organic biocides, such as, for example, phenoxyethanol, phenoxypropanol, glyoxal, thiadiazines, 2,4-dichlorobenzyl alcohols and preferably isothiazolone derivatives, such as, for example, MIT (2-methyl-3(2H)-isothiazolone), CMIT (5-chloro-2-methyl-3(2H)-isothiazolone), CIT (5-chloro-3(2H)-isothiazolone), BIT (1,2-benzisothiazol-3(2H)-one), and furthermore copolymers of N,N-di-C₁-C₁₀-alkyl-ω-amino-C₂-C₄-alkyl (meth)acrylate, in particular copolymers of ethylene with N,N-dimethyl-2-aminoethyl (meth)acrylate, one or more surfactants which may be anionic, cationic or nonionic, active carbon,
colorants, such as, for example, dyes or pigments,
fragrances, such as, for example, perfume,
water repellents or oleophobic agents, for example fluorocarbon resins or fluorocarbon waxes,
odor scavengers, for example cyclodextrins, and
microcapsules filled with at least one active substance, such as, for example, care oil, one or more biocides, perfume or odor scavenger, it being possible in the context of the present invention for microcapsules to be, for example, spherical internally hollow particles having a mean external diameter in the range from 1 to 100 μm, which, for example, may be composed of melamine/formaldehyde resin or of polymethyl methacrylate.

For this purpose, for example, at least one aminoplast foam (b) can be brought into contact in different operations or preferably simultaneously with aqueous formulation of compound (b-1) and with at least one compounding material (d-1).

In an embodiment, one or more compounding materials (d-1) may be added to aqueous formulation of compound (b-1), for example in proportions of from 0 to altogether 50% by weight, based on (b-1), preferably from 0.001 to 30% by weight, particularly preferably from 0.01 to 25% by weight, very particularly preferably from 0.1 to 20% by weight.

After aqueous formulation of compound (b-1) and, if appropriate, catalyst (c-1) and, if appropriate, at least one compounding material (d-1) has been allowed to act on aminoplast foam (b), it is furthermore possible to effect mechanical compression one or more times. The mechanical compression can be carried out batchwise or, preferably, continuously, batchwise, for example, by means of presses or plates, and continuously, for example, by means of rolls or calendars. If it is desired to effect calendering, one or more calender passes can be carried out, for example from one to twenty calender passes, preferably from five to ten calender passes.

In an embodiment of the present invention, compression is effected mechanically to a degree of compaction in the range from 1:1.2 to 1:20, preferably from 1:2.5 to 1:10.

In an embodiment of the present invention, calendering is effected prior to drying.

In an embodiment of the present invention, a procedure is adopted in which, after aqueous formulation of compound (b-1) and, if appropriate, catalyst (c-1) and, if appropriate, at least one compounding material (d-1) has been brought into contact and allowed to act, first drying, then moistening with water and then mechanical compression, for example calendering, are effected.

In another embodiment of the present invention, a procedure is adopted in which, after aqueous formulation of compound (b-1) and, if appropriate, catalyst (c-1) and, if appropriate, at least one compounding material (d-1) has been brought into contact and allowed to act, first drying is effected, moistening is dispensed with and then mechanical compression, for example calendering, is effected.

In an embodiment of the present invention, the unmodified aminoplast foams (a) which are hard per se become soft and flexible as a result of the mechanical compression after aqueous formulation of compound (b-1) and, if appropriate, catalyst (c-1) and, if appropriate, at least one compounding material (d-1) has been brought into contact and allowed to act.

In an embodiment of the present invention, after aqueous formulation of compound (b-1) and, if appropriate, catalyst (c-1) and, if appropriate, at least one compounding material (d-1) has been brought into contact with and allowed to act on aminoplast foam (b), thermal fixing can be effected, in particular before or after the mechanical compression or between two mechanical compression steps. For example, thermal fixing can be effected at temperatures of from 120° C. to 250° C. over a period of from 5 seconds to 120 minutes. Suitable apparatuses are, for example, microwave ovens, plate presses, drying ovens heated by means of hot-air blowers, electrically heated drying ovens or drying ovens heated by means of gas flames, heated roll mills or continuously operated drying means.

Before the thermal fixing, drying can be effected, as described above.

After aqueous formulation of compound (b-1) and, if appropriate, catalyst (c-1) and, if appropriate, at least one compounding material (d-1) has been brought into contact with and allowed to act on aminoplast foam (b), thermal fixing can be effected in particular after or preferably before the mechanical compression or between two mechanical compression steps. For example, thermal fixing can be effected at temperatures of from 150° C. to 200° C. over a period of from 30 seconds to 120 minutes. Suitable apparatuses are, for example, drying ovens.

In a special embodiment, the mechanical compression and the thermal fixing are combined, for example by passing the foam once or several times over hot rolls or calenders or pressing it once or several times between hotplates after an action time has been allowed and, if appropriate, drying has been effected. Of course, it is also possible to effect calendering several times and to effect compression once or several times by means of cold rolls and once or several times by means of hot rolls. In association with the present invention, hot is to be understood as meaning temperatures in the range from 100 to 250° C., preferably from 120 to 200° C.

Aminoplast foams modified as described above have a density in the range from 5 to 1000 kg/m³, preferably from 6 to 500 kg/m³ and particularly preferably in the range from 7 to 300 kg/m³. The density of the foam according to the invention is influenced firstly by the degree of occupation with compound (b-1) and, if appropriate, catalyst (c-1) and, if appropriate, at least one compounding material (d-1) and secondly by the degree of compaction of the starting material. By a suitable choice of degree of occupation and degree of compaction, it is possible to establish density and hardness or flexibility as desired.

In another embodiment of the present invention, open-cell aminoplast foams (b) which have been treated with at least one polymer (b-2) which is solid at room temperature, contains carboxyl groups and/or carboxylic ester groups and has a molecular weight Mₙ in the range from 1000 to 1 000 000 g/mol are used.

In an embodiment of the present invention, polymers (b-2) which are solid at room temperature and contain carboxyl groups and/or carboxylic ester groups are to be understood as meaning those polymers which have a melting point of more than 25° C., preferably more than 50° C., determined by DSC.

Polymers (b-2) which are solid at room temperature and contain carboxyl groups and/or carboxylic ester groups may be homopolymers or copolymers of ethylenically unsaturated mono- or dicarboxylic acids.

In an embodiment of the present invention, polymers (b-2) which are used according to the invention, are solid at room temperature and contain carboxyl groups and/or carboxylic ester groups are organic polymers which differ from the material from which open-cell foam (a) is produced.

Polymers (b-2) which are solid at room temperature and contain carboxyl groups and/or carboxylic ester groups may be polymers having a glass transition temperature T_{g} in the range from −50 to 150° C., preferably from −25 to 120° C. and particularly preferably from −20 to 100° C.

In a preferred embodiment of the present invention, at least one polymer (b-2) which is solid at room temperature and contains carboxyl groups and/or carboxylic ester groups is a copolymer of at least one ethylenically unsaturated carboxylic acid selected from ethylenically unsaturated mono- and dicarboxylic acids, and in particular a copolymer of (meth)acrylic acid.

In a preferred embodiment of the present invention, at least one polymer (b-2) which is solid at room temperature and contains carboxyl groups and/or carboxylic ester groups is a copolymer which is obtainable by copolymerization of

(C) ethylene,
(D) at least one ethylenically unsaturated carboxylic acid,
(E) if appropriate, further comonomers.

Particularly preferred polymers (b-2) which are solid at room temperature and contain carboxyl groups and/or carboxylic ester groups are described in more detail below.

Particularly preferably, polymers (b-2) which are solid at room temperature and contain carboxyl groups and/or carboxylic ester groups are ethylene copolymers which contain as comonomers incorporated in the form of polymerized units:

(C) from 60 to 95% by weight, preferably from 65 to 85% by weight, of ethylene and
(D) from 5 to 40% by weight, preferably from 15 to 35% by weight, of at least one ethylenically unsaturated carboxylic acid,
data in % by weight being based on the total amount of polymer (b-2) which is solid at room temperature and contains carboxyl groups and/or carboxylic ester groups.

At least one ethylenically unsaturated carboxylic acid is preferably a carboxylic acid of the general formula III

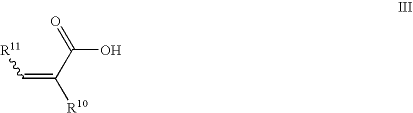

In formula III, the radicals are defined as follows:
R¹⁰ is selected from hydrogen and
C₁-C₁₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl and n-decyl; particularly preferably C₁-C₄-alkyl, such as methyl, ethyl, n-propyl, isopropyl, n-butyl, isobutyl, sec-butyl and tert-butyl;
   R¹¹ is selected from hydrogen,
C₁-C₁₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl and n-decyl; particularly preferably C₁-C₄-alkyl, such as methyl ethyl, n-propyl, isopropyl, n-butyl, isobutyl, sec-butyl and tert-butyl;
COOH, COOCH₃, COOC₂H₅,

Very particularly preferably, R¹¹ is hydrogen and R¹⁰ is hydrogen or methyl.

By way of example, ethylene copolymer used as polymer (b-2) which is solid at room temperature and contains carboxyl groups and/or carboxylic ester groups may comprise, incorporated in the form of polymerized units, up to 40% by weight, preferably up to 35% by weight, based in each case on the sum of ethylene (C) and ethylenically unsaturated carboxylic acid(s) (D) incorporated in the form of polymerized units, of one or more further comonomers (E) for example

vinyl, allyl and methallyl esters of C₁-C₁₀-alkylcarboxylic acids or of formic acid, for example vinyl formate, vinyl propionate and in particular vinyl acetate,
one or more ethylenically unsaturated carboxylic esters, preferably of the formula IV

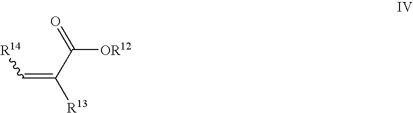

where
R¹² is selected from C₁-C₁₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl and n-decyl; particularly preferably C₁-C₄-alkyl, such as methyl, ethyl, n-propyl, isopropyl, n-butyl isobutyl, sec-butyl and tert-butyl.
R¹³ is selected from hydrogen,
   C₁-C₁₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl and n-decyl; particularly preferably C₁-C₄-alkyl, such as methyl, ethyl, n-propyl, isopropyl, n-butyl, isobutyl, sec-butyl and tert-butyl;
R¹⁴ is selected from hydrogen,
   C₁-C₁₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl and n-decyl; particularly preferably C₁-C₄-alkyl, such as methyl, ethyl, n-propyl, isopropyl, n-butyl, isobutyl, sec-butyl and tert-butyl;
   COOCH₃, COOC₂H₅,
      and furthermore
      vinylaromatic compounds, such as, for example, α-methylstyrene and in particular styrene,
      isobutene and
      α-olefins, such as, for example, CH₂═CH-n-C₁₆H₃₃, CH₂═CH-n-C₁₈H₃₇, CH₂═CH-n-C₂₀H₄₁ and CH₂═CH-n-C₂₂H₄₅.

Very particularly preferably, R¹⁴ is hydrogen and R¹³ is hydrogen or methyl in formula IV.

Very particularly preferably, R¹⁴ is hydrogen and R¹³ is hydrogen or methyl and R¹² is selected from methyl, ethyl, n-butyl and 2-ethylhexyl in formula IV.

Ethylene copolymers described above can advantageously be prepared by free radical copolymerization known per se under high pressure conditions, for example in stirred high-pressure autoclaves or in high-pressure tubular reactors. The preparation in stirred high-pressure autoclaves is preferred. Stirred high-pressure autoclaves are known per se, and a description is to be found in Ullmann's Encyclopedia of Industrial Chemistry, 5th Edition, key words: Waxes, Vol. A 28, page 146 et seq., Verlag Chemie Weinheim, Basel, Cambridge, N.Y., Tokyo, 1996. In them the length/diameter ratio is predominantly in the ranges from 5:1 to 30:1 preferably from 10:1 to 20:1. The high-pressure tubular reactors which can also be used are likewise to be found in Ullmann's Encyclopedia of Industrial Chemistry, 5th Edition, key words: Waxes, Vol. A 28, page 146 et seq., Verlag Chemie Weinheim, Basel, Cambridge, N.Y., Tokyo, 1996.

Suitable pressure conditions for the copolymerization under high pressure conditions are from 500 to 4000 bar, preferably from 1500 to 2500 bar. The reaction temperatures are in the range from 170 to 300° C., preferably in the range from 200 to 280° C.

Modified aminoplast foams preferably comprise in the range from 0.1 to 80% by weight, preferably from 2 to 60% by weight, particularly preferably from 5 to 50% by weight, based on the weight of the corresponding aminoplast foam (b), of solid (b-1) or (b-2).

In a special embodiment of the present invention, the cleaning method according to the invention is carried out in the presence of at least one additive selected from organic solvents, aqueous solutions of at least one surface-active substance, salt solutions, aqueous acids or alkalis.

Examples of particularly preferred acids are phosphoric acid, sulfuric acid, hydrochloric acid, methanesulfonic acid, toluenesulfonic acid, acetic acid, formic acid, citric acid, propionic acid, oxalic acid, tartaric acid and nitric acid. Acid phosphoric esters of C₁-C₁₀-alkanols are also suitable acids.

Examples of particularly preferred alkalis are alkalis such as, for example, potassium hydroxide solution and sodium hydroxide solution.

Examples of particularly preferred organic solvents are terpentine, paraffinic, isoparaffinic and naphthenic hydrocarbons (e.g. mineral oil), acetone, tetrahydrofuran, dimethylformamide, ethyl acetate and ethanol, including denatured ethanol.

Examples of surface-active substances are cationic surfactants and preferably anionic or nonionic surfactants. Those surfactants whose organic ion is positively charged are referred to as cationic surfactants, and those surfactants whose organic ion is negatively charged are referred to as anionic surfactants Examples of particularly preferred anionic surfactants are alkali metal and ammonium salts of C₈-C₁₂-alkylsulfates, alkali metal and ammonium salts of sulfuric acid mono-C₁₂-C₁₈-alkyl esters of ethoxylated alkanols (degree of ethoxylation: from 4 to 30) and alkali metal and ammonium salts of ethoxylated C₄-C₁₂-alkylphenols (degree of ethoxylation: from 3 to 50), of C₁₂-C₁₈-alkanesulfonic acids and of C₉-C₁₈-alkylarylsulfonic acids (aryl radical: phenyl, tolyl, naphthyl).

Examples of particularly preferred surface-active substances are C₄-C₂₀-alkanol ethoxylates, in particular of the formula C₄-C₂₀-alkyl-(EO)_{y}—OH, the HLB value of such alkanol ethoxylates according to W. C. Griffin, i.e. 20 times the mass fraction of ethylene oxide (EO) in the molecule, being from 2 to 19, preferably from 6 to 15, particularly preferably from 8 to 14.

Further preferred surface-active substances are polyalkylene oxides and alkanol alkoxylates, for example EO-PO block copolymers and surfactants having the composition C₄-C₂₀-alkyl-(EO, PO, BuO, PeO)_{y}—OH, where PO is propylene oxide, BuO is butylene oxide and PeO is pentylene oxide, and block and random structures are possible. If the HLB value is calculated as 20 times the mass fraction of ethylene oxide plus 10 times the mass fraction of further alkylene oxide, such as, for example, propylene oxide, it is from 2 to 19, preferably from 6 to 15 particularly preferably from 8 to 14.

If it is desired to carry out the cleaning method according to the invention in the presence of at least one additive, it is possible, for example, to bring aminoplast foam into contact with liquid additive and then to effect cleaning as described above. The bringing into contact can be effected, for example, by soaking, spraying or impregnation.

Aminoplast foam pieces used in the cleaning method according to the invention may be obtained from aminoplast foam, for example by confectioning. Suitable confectioning methods are, for example, casting, punching, cutting, shredding, plucking, sawing, milling, grinding in an edge mill and shearing.

When the method according to the invention is carried out, abraded material comprising aminoplast foam is produced, which in turn cleans but does not have an abrasive effect on surfaces to be cleaned. Impurities are removed from the surface to be cleaned or are taken up in or on aminoplast foam pieces. The surface to be cleaned is thus well protected and at the same time very good cleaning effect is obtained.

The present invention furthermore relates to aminoplast foam pieces produced from
(a) open-cell aminoplast foams having a density in the range from 5 to 500 kg/m³ and a mean pore diameter in the range from 1 μm to 1 mm or
(b) open-cell aminoplast foams having a density in the range from 5 to 500 kg/m³ and a mean pore diameter in the range from 1 μm to 1 mm, which have been treated
(b1) with an aqueous formulation of at least one compound (b-1) having at least one hemiaminal or animal group per molecule or at least one copolymer which comprises, incorporated in the form of polymerized units, at least one comonomer containing OH groups or β-dicarbonyl groups or epoxide groups, or
(b2) with at least one polymer (b-2) which is solid at room temperature, contains carboxyl groups and/or carboxylic ester groups and has a molecular weight Mₙ in the range from 1000 to 1 000 000 g/mol,
   the aminoplast foam pieces according to the invention having an average diameter in the range from 0.1 to 5 mm (weight average) preferably from 1 mm to 10 mm.

The present invention furthermore relates to the use of aminoplast foam pieces according to the invention for cleaning surfaces, in particular poorly accessible surfaces.

The present invention furthermore relates to a method for cleaning surfaces using aminoplast foam pieces according to the invention, modified or unmodified, wherein the surfaces are treated with a composite comprising a flexible substrate and aminoplast foam pieces fixed thereon. The treatment can be effected by rubbing, wiping, scrubbing or polishing the surface to be cleaned once or several times with the abovementioned composite. The abovementioned composite can be used in moistened or in dry form.

The present invention furthermore relates to composites comprising a flexible substrate and aminoplast foam pieces according to the invention which are fixed thereon. Composites according to the invention comprise aminoplast foam pieces according to the invention which are fixed on a preferably flexible substrate. Flexible substrates are understood as meaning those materials which can be bent manually without breaking or irreversibly changing, for example by cracking or white fracture.

In a preferred embodiment of the present invention, composites according to the invention comprise a fibrous substrate as the flexible substrate.

Examples of suitable fibrous substrates are:

paper, board, leather, imitation leather, foams and in particular textile materials, such as, for example, woven fabrics, weft knitted fabrics, knitted fabrics, filaments, fibers, microfibers, nonwovens of natural or of manmade fibers or blends of natural or manmade fibers and, if appropriate, one or more binders. Natural fibers may be, for example, of cotton, wool, flax, hemp or ramie. Manmade fibers may be, for example, polyamide, polyester, modified polyester, polyester blended fabrics, polyamide blended fabrics, polyacrylonitrile, triacetate, acetate, polycarbonate, polypropylene, polyvinyl chloride, polyester microfibers and glass fiber fabrics. Textile materials usually used for cleaning purposes are very particularly suitable.

Specific examples of fibrous substrates are sponge cloths, for example nonwovens produced using manmade fibers, such as, for example, dusters.

Other specific examples of suitable fibrous substrates are brushes.

The preferably flexible substrate and in particular fibrous substrate may have any desired shape and size.

In an embodiment of the present invention, composites according to the invention are those wherein aminoplast foam pieces according to the invention, in particular those having an average diameter in the range of from 0.1 to 5 mm, are fixed in a 0.1 to 10 mm thick layer on the flexible substrate.

In a special embodiment of the present invention, aminoplast foam pieces according to the invention, in particular those having an average diameter in the range of from 0.1 to 5 mm, are fixed in a 0.1 to 10 mm thick layer on individual filaments as the flexible substrate. Said composites can be used, for example, as floss for cleaning poorly accessible surfaces.

In a special embodiment of the present invention, aminoplast foam pieces according to the invention, in particular those having an average diameter in the range of from 0.1 to 5 mm, are fixed in a 0.1 to 10 mm thick layer on individual fibers or microfibers as the flexible substrate. For example, nonwovens can be produced from fibers or microfibers coated in this manner.

The present invention furthermore relates to a process for the production of composites according to the invention, also referred to as production process according to the invention, wherein the flexible substrate is treated with a preferably aqueous aminoplast foam piece formulation comprising aminoplast foam pieces according to the invention.

The treatment can be carried out, for example, by coating, such as, for example, knife coating, application or padding. Treatment can furthermore be effected by spraying. By the treatment according to the invention, it is possible to produce a complete film of preferably aqueous formulation which comprises aminoplast foam pieces according to the invention on the substrate or an incomplete film which has, for example a pattern. For this purpose, it is possible to use methods known per se, for example with the use of templates, by pressing on or spraying on preferably aqueous formulation or distributing said formulation with the aid of robots having, for example, movable robot arms.

In an embodiment of the present invention, the flexible substrate is treated on only one side with an aminoplast foam piece formulation comprising aminoplast foam pieces, for example by spraying on. The spraying on can be carried out for this purpose, for example, using an atomizer. This embodiment is preferred particularly when the flexible substrate is a highly porous substrate which is to be brought into contact only on one side with aminoplast foam piece formulation.

In a special embodiment of the present invention, the back of a composite according to the invention, i.e. the side on which no aminoplast foam pieces according to the invention are fixed, is coated with a care substance. Care substances are understood as meaning, for example, natural or synthetic waxes, natural or synthetic oils and polishes. Such special composites according to the invention additionally have a care or sealing effect in the cleaning of surfaces.

Preferably aqueous aminoplast foam piece formulations suitable for carrying out the production process according to the invention may furthermore comprise one or more resins (α) or polymers (β) in addition to aminoplast foam pieces according to the invention and solvent, for example organic solvent, such as, for example, ethanol, or preferably water.

Aminoplast foam piece formulation used according to the invention is preferably a paste, emulsion or dispersion, solution or suspension which, in addition to organic solvent or preferably water, comprises

aminoplast foam pieces and
one or more resins (α) or polymers (β).

In an embodiment of the present invention, aminoplast foam piece formulation used according to the invention has a dynamic viscosity of more than 50 to 200 dPa·s, determined at 23° C., preferably in the range of from 60 to 180 dPa·s. Dynamic viscosities can be determined, for example, using a Brookfield Viscometer.

Resins (α) or polymers (β) may be any desired organic resins or polymers and include in each case copolymers. The following may be mentioned by way of example for preferred polymers (β): polymers containing ester groups, polymers containing amido groups, polymers containing ether groups, polymers containing urethane groups, it being possible for ester groups, ether groups, amido groups or urethane groups to be part of the main chain or to form side chains. Preferred organic polymers (β) are polyurethanes and polyacrylates, in particular anionic polyurethanes.

In a preferred embodiment of the present invention, aminoplast foam piece formulation used according to the invention comprises at least one resin (α) which is selected from compounds of the formulae Ia and Ib, or at least one polymer (β) selected from preferably anionic polyurethanes, (co)polymers of C₁-C₁₀-alkyl (meth)acrylates and copolymers of C₁-C₁₀-alkyl (meth)acrylates with at least one ethylenically unsaturated compound.

In an embodiment of the present invention, aminoplast foam piece formulation used according to the invention comprises two or more different polymers (β), for example two different polyurethanes or two different (co)polymers of (co)polymers of C₁-C₁₀-alkyl (meth)acrylates or a polyurethane and a (co)polymer of C₁-C₁₀-alkyl (meth)acrylate.

In an embodiment of the present invention, polymer (β) has a dynamic viscosity in the range of from 1 to 300 mPa·s, preferably from 5 to 100 mPa·s, measured at 25° C.

For the purposes of the present invention, anionic polyurethanes are obtainable, for example, by reacting one or more aromatic or preferably aliphatic or cycloaliphatic diisocyanates with one or more polyester diols.

Suitable aromatic diisocyanates are, for example, toluylene 2,4-diisocyanate and diphenylmethane 2,4′-diisocyanate (2,4′-MDI). Suitable aliphatic diisocyanates are, for example, hexamethylene diisocyanate and dodecamethylene diisocyanate.

Suitable cycloaliphatic diisocyanates are, for example, methylenebis(cyclohexyl) 2,4′-diisocyanate, 4-methylcyclohexane 1,3-diisocyanate (H-TDI), isophorone diisocyanate (IPDI) and biscyclohexylmethylene 4,4′-diisocyanate.

Suitable polyesterdiols are obtainable by polycondensation of one or more preferably aliphatic or cycloaliphatic diols and one or more aromatic or preferably aliphatic dicarboxylic acids.

Examples of suitable aliphatic diols are: ethylene glycol, 1,3-propanediol, 1,4-butanediol, 1,6-hexanediol, 1,12-dodecanediol, propylene glycol 1,2-propanediol), butylene glycol (1,2-butanediol) and neopentyl glycol.

Examples of suitable cycloaliphatic diols are: cis-1,4-cyclohexanedimethanol, trans-1,4-cyclohexanedimethanol, cis-1,3-cyclohexanedimethanol and trans-1,3-cyclohexane-dimethanol.

Examples of suitable aromatic dicarboxylic acids are terephthalic acid, phthalic acid and in particular isophthalic acid.

Examples of suitable aliphatic dicarboxylic acids are succinic acid, glutaric acid and in particular adipic acid.

Vera particularly suitable polyesterdiols are obtainable, for example, by polycondensation or at least two different aliphatic or cycloaliphatic diols with at least one aromatic or preferably aliphatic dicarboxylic acid, for example from isophthalic acid, adipic acid and 1,4-cyclohexanedimethanol or from adipic acid, neopentyl glycol and 1,6-hexanediol.

In an embodiment of the present invention, particularly suitable polyesterdiols have an acid number in the range of from 0.1 to 200 mg KOH/g of polyesterdiol, determined according to DIN 53402.

In another embodiment of the present invention, particularly suitable polyesterdiols have a hydroxyl number in the range of from 10 to 200 mg KOH/g of polyesterdiol, determined according to DIN 53240.

(Co)polymers of C₁-C₁₀-alkyl (meth)acrylates and copolymers of C₁-C₁₀-alkyl (meth)acrylates with at least one ethylenically unsaturated compound are, for example, block copolymers and preferably random copolymers which comprise as comonomers incorporated in the form of polymerized units:

from 40 to 95% by weight, preferably, 50 to 90% by weight, of one or more C₁-C₁₀-alkyl (meth)acrylates, preferably C₄-C₈-alkyl (meth)acrylates, for example methyl (meth)acrylates, ethyl (meth)acrylate, n-propyl (meth)acrylate, isopropyl (meth)acrylate, n-decyl (meth)acrylate, preferably n-butyl (meth)acrylate, isobutyl (meth)acrylate, n-hexyl (meth)acrylate, n-octyl (meth)acrylate, 2-ethylhexyl (meth)acrylate, particularly preferably n-butyl (meth)acrylate and 2-ethylhexyl (meth)acrylate,
from 0.1 to 10% by weight, preferably from 1 to 5% by weight, of one or more ethylenically unsaturated carboxylic acids, for example methacrylic acid or in particular acrylic acid,
from 0 to 50% by weight, preferably from 1 to 40% by weight, of at least one further ethylenically unsaturated compound, selected from
vinylaromatic compounds, such as, for example, α-methylstyrene, para-methylstyrene, para-n-butylstyrene and in particular styrene,
(meth)acrylonitrile,

### N-methylol(meth)acrylamide,

vinyl esters of aliphatic carboxylic acids, for example vinyl propionate and in particular vinyl acetate.

In a preferred embodiment of the present invention, organic polymer (β) is composed of from 40 to 95% by weight, preferably from 50 to 90% by weight, of at least one C₁-C₁₀-alkyl (meth)acrylate, preferably ethyl acrylate, n-butyl acrylate and/or 2-ethylhexyl acrylate,

from 0.1 to 10% by weight, preferably from 1 to 5% by weight, of methacrylic acid or in particular acrylic acid, and
from 0 to 50% by weight, preferably from 1 to 40% by weight, of at least one ethylenically unsaturated compound, in particular styrene, vinyl acetate or (meth)acrylonitrile.

In an embodiment of the present invention, a polymer (β) is a sell-crosslinking (co)polymer, for example prepared from one or more C₁-C₁₀-alkyl (meth)acrylates with acrylic acid and N-methylol(meth)acrylamide.

In a special embodiment of the present invention, aminoplast foam piece formulation used according to the invention comprises a mixture of at least two organic polymers (β), comprising from 40 to 99.9% by weight of a thermally crosslinkable copolymer of C₁-C₁₀-alkyl (meth)acrylates with (meth)acrylic acid and optionally further ethylenically unsaturated compounds, and from 0.1 to 60% by weight of anionic polyurethane, data in % by weight being based in each case on the solids content of the relevant mixture.

Aminoplast foam piece formulation used according to the invention may furthermore comprise assistants, for example biocides, surfactants, active carbon, colorants, fragrances, odor scavengers, antifoams or thickeners

Suitable antifoams are, for example, silicone-containing antifoams, such as, for example, those of the formula HO—(CH₂)₃—(CH₃)Si[OSi(CH₃)₃]₂ or HO—(CH₂)₃—(CH₃)Si[OSi(CH₃)₃][OSi(CH₃)₂OSi(CH₃)₃], unalkoxylated or in each case alkoxylated with up to 20 equivalents of alkylene oxide and in particular ethylene oxide. Silicone-free antifoams are also suitable, such as, for example, polyalkoxylated alcohols, e.g. fatty alcohol alkoxylates, preferably straight-chain C₁₀-C₂₀-alkanols, preferably having a degree of ethoxylation of from 2 to 50, straight-chain C₁₀-C₂₀-alkanols and 2-ethylhexan-1-ol. Further suitable antifoams are fatty acid C₈-C₂₀-alkyl esters, preferably C₁₀-C₂₀-alkyl stearates, in which C₈-C₂₀-alkyl, preferably C₁₀-C₂₀-alkyl, may be straight-chain or branched.

Suitable thickeners are, for example, natural or synthetic thickeners. The use of synthetic thickeners is preferred, for example of generally liquid solutions of synthetic polymers in, for example, white oil or as aqueous solutions. Polymers suitable as thickeners comprise acid groups which are neutralized with ammonia completely or up to a certain percentage. In the fixing process, ammonia is liberated, with the result that the pH is reduced and the actual fixing begins. The reduction of pH necessary for the fixing can alternatively be brought about by addition of nonvolatile acids, such as, for example, citric acid, succinic acid, glutaric acid or malic acid.

Preferred examples of synthetic thickeners are copolymers with from 85 to 95% by weight of acrylic acid, from 4 to 14% by weight of acrylamide and up to 1% by weight, preferably up to 0.1% by weight, of the (meth)acrylamide derivative of formula IV

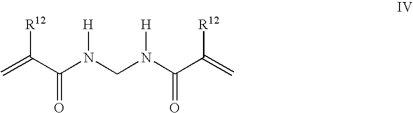

having molecular weights M_{w} in the range of from 100 000 to 200 000 g/mol, where R¹² may be identical or different and is hydrogen or methyl.

Further assistants present in aminoplast foam piece formulation used according to the invention are, for example, fastness improvers, plasticizers, handle improvers, wetting agents, leveling agents, water softeners, such as, for example, complexing agents, urea, active substances, such as, for example, biocides or flameproofing agents, and dispersants.

Examples of particularly suitable plasticizers are ester compounds selected from the groups consisting of the aliphatic or aromatic di- or polycarboxylic acids completely esterified with alkanols and phosphoric acid monoesterified with alkanol.

Preferred examples of aromatic di- or polycarboxylic acids completely esterified with C₁-C₁₀-alkanol are phthalic acid, isophthalic acid and mellitic acid completely esterified with alkanol; the following may be mentioned by way of example: di-n-octyl phthalate, di-n-nonyl phthalate di-n-decyl phthalate, di-n-octyl isophthalate, di-n-nonyl isophthalate and di-n-decyl isophthalate.

Preferred examples of aliphatic di- or polycarboxylic acids completely esterified with C₁-C₁₀-alkanol are, for example, dimethyl adipate, diethyl adipate, di-n-butyl adipate, diisobutyl adipate, dimethyl glutarate, diethyl glutarate, di-n-butyl glutarate, diisobutyl glutarate, dimethyl succinate, diethyl succinate, di-n-butyl succinate, diisobutyl succinate and mixtures of the abovementioned compounds.

Preferred examples of phosphoric acid at least nnonoesterified with C₁-C₁₀-alkanol are C₁-C₁₀-alkyl di-C₆-C₁₄-aryl phosphates, such as isodecyl diphenyl phosphate.

Further suitable examples of plasticizers are aliphatic or aromatic di- or polyols at least monoesterified at least monoesterified with C₁-C₁₀-alkylcarboxylic acid.

Preferred examples of aliphatic or aromatic di- or polyols at least monoesterified with C₁-C₁₀-alkylcarboxylic acid is 2,2,4-trimethylpentane-1,3-diol monoisobutyrate.

Further suitable plasticizers are polyesters, obtainable by polycondensation of aliphatic dicarboxylic acid and aliphatic diol, for example adipic acid or succinic acid and 1,2-propanediol, preferably having an M_{w} of 200 g/mol, and polypropylene glycol alkylphenyl ether, preferably having an M_{w} of 450 g/mol.

Further suitable plasticizers are polypropylene glycols etherified with two different alcohols and having a molecular weight M_{w} in the range of from 400 to 800 g/mol, where one of the alcohols can preferably be an alkanol, in particular a C₁-C₁₀-alkanol and the other alcohol can preferably be an aromatic alcohol, for example for o-cresol, m-cresol, p-cresol and in particular phenol.

In an embodiment of the present invention, aminoplast foam piece formulation used according to the invention comprises

in the range of from 1 to 99% by weight, preferably from 10 to 80% by weight, particularly preferably from 30 to 70% by weight, of aminoplast foam pieces according to the invention,
in the range of from 99 to 1% by weight, preferably from 90 to 20% by weight, particularly preferably from 70 to 30% by weight % by weight, of resin (α) or polymer (β),
if appropriate, in the range of from 0.1 to 20% by weight, preferably from 0.5 to 10% by weight, particularly preferably from 1 to 5% by weight, of assistants, the remainder being solvent and in particular water.

If it is desired to use those aminoplast foam piece formulations which comprise resin (α), one or more catalysts selected from metal and ammonium salts and inorganic or organic acids can be added to aminoplast foam piece formulation used according to the invention. Suitable metal salts are, for example, metal halides, metal sulfates, metal nitrates, metal tetrafluoroborates, metal phosphates or mixtures thereof. Examples are magnesium chloride, magnesium sulfate, zinc chloride, lithium chloride, lithium bromide, boron trifluoride, aluminum chloride, aluminum sulfate, alums, such as, for example, KAI(SO₄)₂·12H₂O, zinc nitrate, sodium tetrafluoroborate and mixtures of the abovementioned metal salts. Suitable ammonium salts are, for example, ammonium chloride and ammonium sulfate. Suitable acids are, for example, dilute aqueous inorganic acids, such as hydrochloric acid or sulfuric acid, and organic acids, such as, for example, formic acid, acetic acid, p-toluenesulfonic acid, methanesulfonic acid or amidopropanesulfonic acid.

In an embodiment of the present invention, drying is effected after the treatment of flexible substrate with aminoplast foam piece formulation, for example at temperatures in the range of from 20 to 190° C., preferably from 50 to 170° C.

The present invention furthermore relates to aminoplast foam piece formulations, preferably aqueous aminoplast foam piece formulations, comprising at least aminoplast foam pieces according to the invention and at least one resin (α) or polymer (β). Aminoplast foam piece formulations according to the invention are particularly suitable for carrying out the production process according to the invention.

In an embodiment of the present invention, aminoplast foam piece formulation according to the invention has a dynamic viscosity of more than 50 to 200 dPa·s, determined at 23° C., preferably in the range of from 60 to 130 dPa·s.

In an embodiment of the present invention, aminoplast foam piece formulation according to the invention comprises

in the range of from 1 to 99% by weight, preferably from 10 to 80% by weight, particularly preferably from 30 to 70% by weight, of aminoplast foam pieces according to the invention,
in the range of from 99 to 1% by weight, preferably from 90 to 20% by weight, particularly preferably from 70 to 30% by weight % by weight of resin (α) or polymer (β),
if appropriate, in the range of from 0.1 to 20% by weight, preferably from 0.5 to 10% by weight, particularly preferably from 1 to 5% by weight, of assistants, the remainder being solvent and in particular water.

The present invention furthermore relates to a process for the production of aminoplast foam piece formulations according to the invention. Aminoplast foam piece formulations according to the invention can be produced, for example, by mixing aminoplast foam pieces according to the invention, resin (α) or polymer (β) and at least one solvent, preferably water, and, if appropriate, one or more assistant.

The invention is explained by the working examples. Data in % denote percentages by weight, if not expressly stated otherwise

### Working Examples

### I.1 Preparation of Aminoplast Foam (a.1)

In an open vessel, a spray-dried melamine/formaldehyde precondensate (molar ratio 1:3, molecular weight about 500 g/mol) was added to an aqueous solution comprising 3% by weight of formic acid and 1.5% of the sodium salt of a mixture of alkanesulfonates having 12 to 18 carbon atoms in the alkyl radical (emulsifier K30 from Bayer AG), the percentages being based on the melamine/formaldehyde precondensate. The concentration of the melamine/formaldehyde precondensate was 74% by weight, based on the total mixture comprising melamine/formaldehyde precondensate and water. The mixture thus obtained was vigorously stirred, after which 20% by weight of n-pentane were added. Stirring was continued (for about 3 min) until a dispersion having a homogeneous appearance formed. This was applied by knife coating to a Teflon-coated glass fabric as substrate material and was foamed and cured in a drying oven in which an air temperature of 150° C. prevailed. The boiling point of the n-pentane, which is 371.0° under these conditions, resulted as the material temperature in the foam. The maximum rise height of the foam was reached after 7 to 8 min. The foam was left in the drying oven for a further 10 min at 150° C.; thereafter, it was annealed for 30 min at 180° C. (Unmodified) aminoplast foam (a.1) was obtained.

The following properties were determined for the unmodified foam (a.1):

99.6% open-cell character according to DIN ISO 4590,
compressive strength (40%) 1.3 kPa, determined according to DIN 53577,
density 7.6 kg/m³, determined according to EN ISO 845,
mean pore diameter 210 μm, determined by evaluation of micrograph of sections,
BET surface area of 6.4 m²/g, determined according to DIN 66131,
sound absorption of 93%, determined according to DIN 52215,
sound absorption of more than 0.9, determined according to DIN 52212.
I.2 Production of Aminoplast foam Pieces According to the Invention

### I.2.1 Production of Aminoplast Foam Pieces According to the Invention by Cutting

A cuboid of aminoplast foam (a.1) was comminuted manually using a chopping knife until irregular aminoplast foam pieces according to the invention which have a diameter of from 2 to 5 mm had formed. 10 aminoplast foam pieces according to the invention (random sample) had the following dimensions according to table 1 (in mm) according to manual measurement:

| Length | Width | Height (in each case in mm) |
|---|---|---|
| 3 | 6 | 6 |
| 4 | 2 | 5 |
| 3 | 2 | 3 |
| 4 | 6 | 1 |
| 3 | 3 | 2 |
| 5 | 1 | 5 |
| 2 | 5 | 6 |
| 5 | 4 | 4 |
| 2 | 1 | 1 |
| 5 | 4 | 1 |

I.2.2 Production of Aminoplast foam Pieces According to the Invention by Milling

A cuboid of aminoplast foam (a.1) was milled with the aid of a fly cutter-operated laboratory analytical mill (type A10) and then screened over a vibrating sieve of mesh size 250 μm. Aminoplast foam pieces according to the invention having an average diameter of up to 250 μm were obtained. The sieve residue was discarded.

### II. Cleaning, According to the Invention, of Surfaces

100 ml of aminoplast foam pieces (loose heap) from example I.2 were moistened with water and introduced into a 300 ml stirred vessel having a propeller stirrer (in each case of stainless steel) with caked-on material (CaCO₃). The propeller stirrer was then switched on and was operated for 6 hours at 1000 rpm. The stirred vessel was then emptied. Neither the surface of the propeller stirrer nor the internal surface of the vessel was scratched or polished. The caked-on material had been removed completely also from weld seams and narrow angles and scores.

### III. Production of Composites According to the Invention

III.1 Production of Aminoplast foam Piece Formulations According to the Invention

### III.1.1 Production of Aminoplast Foam Piece Formulation AF-1.1 According to the Invention

The following were mixed with one another in a 150 ml polyethylene beaker:

0.6 g of aminoplast foam pieces according to the invention from example I.2.2
5 g of an aqueous dispersion (pH from 3 to 4, unneutralized, solids content 50%) of a polymer (β.1) of 75% by weight of acrylic acid and 25% by weight of maleic acid, crosslinked with 30 mol % of triethanolamine. Mixing was continued until a spreadable, lump-free paste was present, and aminoplast foam piece formulation AF-1.1 according to the invention was obtained.

### III.1.2 Production of Aminoplast Foam Piece Formulation AF-1.2 According to the Invention

The following were mixed with one another in a 150 ml polyethylene beaker:

1 g of aminoplast foam pieces according to the invention from example I.2.2
5 g of an aqueous dispersion (pH from 3 to 4, unneutralized, solids content 50%) of a polymer (β.1) of 75% by weight of acrylic acid and 25% by weight of maleic acid, crosslinked with 30 mol % of triethanolamine. Mixing was continued until a spreadable, lump-free paste was present, and aminoplast foam piece formulation AF-1.2 according to the invention was obtained.

### III.1.3 Production of Aminoplast Foam Piece Formulation AF-1.3 According to the Invention

The following were mixed with one another in a 150 ml polyethylene beaker:

1 g of aminoplast foam pieces according to the invention from example I.2.2 and 1 g of water. A powder having a dry appearance was obtained. A further 0.5 g of water and
5 g of an aqueous dispersion (pH from 3 to 4, unneutralized, solids content 50%) of a polymer (β.1) of 75% by weight of acrylic acid and 25% by weight of maleic acid, crosslinked with 30 mol % of triethanolamine, were then added. Mixing was continued until a spreadable, lump-free paste was present, and aminoplast foam piece formulation AF-1.3 according to the invention was obtained.

### III.1.4 Production of Aminoplast Foam Piece Formulation AF-1.4 According to the Invention

The following were mixed with one another in a 150 ml polyethylene beaker:

1 g of aminoplast foam pieces according to the invention from example I.2.2
5 g of an aqueous dispersion (pH from 3 to 4, unneutralized, solids content 50%) of a polymer (β.1) of 75% by weight of acrylic acid and 25% by weight of maleic acid, crosslinked with 30 mol % of triethanolamine and neutralized with 25% by weight of aqueous ammonia solution to a pH of 7. Mixing was continued until a spreadable, lump-free paste was present, and aminoplast foam piece formulation AF-1.4 according to the invention was obtained.

### III.1.5 Production of Aminoplast Foam Piece Formulation AF-1.5 According to the Invention

Polymer (β.2): polyurethane prepared from

53.7% by weight of polyesterdiol having a hydroxyl number of 55 mg KOH/g of polyesterdiol and an acid number of 1.0 mg KOH/g of polyesterdiol, which is prepared from adipic acid, 2,2-dimethylpropan-1,3-diol and 1,6-hexanediol (molar ratio 2:0.4:0.7), and
17.5% by weight of isophorone diisocyanate and
14.8% by weight of 1,1′ methylenebis(4-isocyanatocyclohexane)

The following were mixed with one another in a 150 ml polyethylene beaker:

1 g of aminoplast foam pieces according to the invention from example I.2.2
5 g of an aqueous dispersion (solids content 50%) of polymer (β.2). Mixing was continued until a spreadable, lump-free paste was present, and aminoplast foam piece formulation AF-1.5 according to the invention was obtained.

### III.1.6 Production of Aminoplast Foam Piece Formulation AF-1.6 According to the Invention

Polymer (β.3): mixture of two hydrophilic polyurethanes, prepared according to EA-A 1 426 391, example 3.

The following were mixed with one another in a 150 ml polyethylene beaker:

1 g of aminoplast foam pieces according to the invention from example I.2.2
6.25 g of an aqueous dispersion (solids content 40%) of polymer (β.3). Mixing was continued until a spreadable, lump-free paste was present, and aminoplast foam piece formulation AF-1.6 according to the invention was obtained.

### III.1.7 Production of Aminoplast Foam Piece Formulation AF-1.7 According to the Invention

Polymer (β.4): poly-n-butyl acrylate having a molecular weight Mₙ of 1 500 000 g/mol.

The following were mixed with one another in a 150 ml polyethylene beaker:

1 g of aminoplast foam pieces according to the invention from example I.2.2
6.25 g of an aqueous dispersion (solids content 40%) of polymer (β.4). Mixing was continued until a spreadable, lump-free paste was present, and aminoplast foam piece formulation AF-1.7 according to the invention was obtained.

### III.1.8 Production of Aminoplast Foam Piece Formulations AF-1.8.1 to AF-1.8.3 According to the Invention

General method for AF-1.8.1 by way of example

Polymer (β.5): 26.2% by weight of methacrylic acid, 73.8% by weight of ethylene, melting range from 75 to 85° C., measured according to DIN 51007, ρ 0.9613 g/cm³, MFI 10.5 g/10 min, measured at 120° C. and under a load of 325 g according to DIN 53735, acid number 170.5 mg KOH/g, quantitatively neutralized with ammonia, in the form of an aqueous dispersion, solids content 25.3% by weight.

40 g of an aqueous dispersion comprising 40 g of the abovementioned aqueous dispersion of polymer (β.5) was initially taken in a 100 ml beaker. 0.4 g of aminoplast foam pieces according to the invention from example I.2.2 was added and stirring was continued until a spreadable, lump-free paste was present, and aminoplast foam piece formulation AF-8.1 according to the invention was obtained.

For the production of aminoplast foam piece formulations AF-8.2 and AF-8.3 according to the invention, an analogous procedure was adopted but stirring was affected with 0.8 and 1.6 g, respectively, of aminoplast foam pieces according to the invention from example I.2.2.

### III.2 Treatment According to the Invention of the Textile Substrate

III.2.1 Treatment According to the Invention of Textile Substrate by Application with a Spatula

In each case a blended polyester/cotton 35/65 fabric, colored ultra marine blue, color according to RAL: No. 5002, weight per unit area: 240 m², was as a flexible substrate.

### General Method:

An approximately 1 mm thick wet layer of aminoplast foam piece formulation according to the invention, as shown in table 2, was applied with a spatula to the textile substrate described above. Drying was effected for 2 hours in a through-circulation drying oven at the temperature stated in table 2. Composites according to the invention, as shown in table 2, were obtained.

### III.2.2 Treatment According to the Invention by Spraying on

### General Method:

In each case a duster (nonwoven) of polypropylene, size 10·20 cm, weight per unit area 0.01 g/cm², was used as a textile substrate.

Aminoplast foam piece formulation according to the invention, as shown in table 3, was introduced into an atomizer. An amount of aminoplast foam piece formulation according to the invention as shown in table 3 was then sprayed onto the duster. Thereafter, drying was effected for one hour in a through-circulation drying oven at 110° C. at atmospheric pressure dried. Composites according to the invention as shown in table 3 were obtained.

### III.3 Cleaning Surfaces Using Composites According to the Invention

Lines were drawn with a Parker ballpoint pen (blue) and a felt tip pen (Staedler permanent Lumocolor, black, waterproof, M) on a white desk top (plastic-coated wood).

Composite according to the invention as shown in table 2 or 3 was moistened, if appropriate, with water and the desk top (surface) was cleaned by lightly wiping several times with the respective dry or moistened composite according to the invention. The results are shown in tables 2 and 3.

TABLE 2
Composites according to the invention, production and cleaning properties

| | | | | Cleaning, dry | | Cleaning, wet | |
|---|---|---|---|---|---|---|---|
| Polymer | | Drying | | Ballpoint | Felt tip | Ballpoint | Felt tip |
| (β) | Example | [° C.] | Composite | pen | pen | pen | pen |
| (β.1) | AF-1 | 160 | VB.1 | | | | |
| (β.1) | AF-2 | 160 | VB.2 | n.d. | n.d. | good | good |
| (β.1) | AF-3 | 160 | VB.3 | good | good | good | good |
| (β.1) | AF-4 | 160 | VB.4 | good | good | good | good |
| (β.2) | AF-5 | 25 | VB.5 | very good | good | very good | very good |
| (β.2) | AF-5 | 120 | VB.6 | good | very good | very good | very good |
| (β.3) | AF-6 | 25 | VB.7 | n.d. | n.d. | very good | very good |
| (β.3) | AF-6 | 120 | VB.8 | good | good | n.d. | n.d. |
| (β.4) | AF-7 | 25 | VB.9 | good | n.d. | very good | very good |
| (β.4) | AF-7 | 120 | VB.10 | n.d. | good | very good | very good |

TABLE 3
Composites according to the invention based on a coated duster

| | | | | Cleaning, dry | | Cleaning, wet | |
|---|---|---|---|---|---|---|---|
| Polymer | | Application | | Ballpoint | Felt tip | Ballpoint | Felt tip |
| (β) | Example | [g/0.002 m²] | Composite | pen | pen | pen | pen |
| (β.5) | AF-8.1 | 5 | VB.8.1 | good | good | good | very |
| | | | | | | | good |
| (β.5) | AF-8.1 | 10 | VB.8.2 | good | very | very | very |
| | | | | | good | good | good |
| (β.5) | AF-8.2 | 20 | VB.8.3 | very | very | very | very |
| | | | | good | good | good | good |
| (β.5) | AF-8.2 | 10 | VB.8.4 | good | very | very | very |
| | | | | | good | good | good |
| (β.5) | AF-8.3 | 5 | VB.8.5 | good | good | good | very |
| | | | | | | | good |
| (β.5) | AF-8.3 | 10 | VB.8.6 | good | very | very | very |
| | | | | | good | good | good |
| (β.5) | AF-8.3 | 20 | VB.8.7 | very | very | very | very |
| | | | | good | good | good | good |

n.d.: not determined

1-19. (canceled)

20: A method for cleaning surfaces using melamine foam pieces produced from
(a) open-cell melamine foams having a density in the range from 5 to 500 kg/m³ and a mean pore diameter in the range from 1 μm to 1 mm or
(b) open-cell melamine foams having a density in the range from 5 to 500 kg/m³ and a mean pore diameter in the range from 1 μm to 1 mm, which have been treated
(b1) with an aqueous formulation of at least one compound (b-1) having at least one hemiaminal or aminal group per molecule or at least one copolymer which comprises, incorporated in the form of polymerized units, at least one comonomer containing OH groups or β-dicarbonyl groups or epoxide groups, or
(b2) with at least one polymer (b-2) which is solid at room temperature, contains carboxyl groups and/or carboxylic ester groups and has a molecular weight Mₙ in the range from 1000 to 1 000 000 g/mol,
the melamine foam pieces used having an average diameter (number average) in the range from 0.1 mm to 50 mm.

21: The method according to claim 20, wherein at least one compound (b-1) has not been used in the preparation of open-cell foam (b).

22: The method according to claim 20, wherein compound (b-1) is obtained by condensation of at least one nitrogen-containing compound (B1) and at least one carbonyl compound (B2) and, if appropriate, further compounds (B3) and, if appropriate, further reactions after the condensation.

23: The method according to claim 20, wherein surfaces to be cleaned are surfaces which are poorly accessible.

24: The method according to claim 20, wherein surfaces to be cleaned are selected from inner surfaces of gears, reaction vessels, kneading tools, stirrers and ball bearings.

25: The method according to claim 20, wherein impurities comprising at least one substance which is selected from fats, oils, waxes, lime soap, biofilms, polymers, metal oxides, metal hydroxides, residues of lubricants and broken emulsions are removed by the cleaning.

26: The method according to claim 20, which is carried out in the presence of an additive selected from organic solvents, aqueous solutions of at least one surface-active substance, salt solutions and aqueous acid or alkali.

27: The method according to claim 20, wherein, in (b), at least one compound (b-1) selected from compounds of the general formula I a and I b 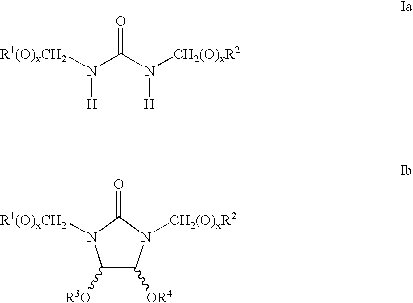
are brought into contact, the variables being defined as follows:
R¹ and R² are identical or different and are selected from hydrogen, C₁-C₁₂-alkyl, branched or straight-chain, (—CH₂—CH₂—O)ₘ—R⁵, (CHCH₃—CH₂—O)ₘ—R⁵, (—CH₂—CHCH₃O)ₘ—R⁵, (—CH₂—CH₂—CH₂O)ₘ—R⁵, (—CH₂—CH₂—CH₂—CH₂—O)ₘ—R⁵,
x are identical or different and are an integer selected from zero and one, at least one x being chosen to be equal to 1 formula I a,
m is an integer in the range from 1 to 20,
R³ and R⁴ are identical or different and are selected from hydrogen, C₁-C₁₂-alkyl, branched or straight-chain, or together are C₂-C₄-alkylene and
R⁵ are identical or different and are selected from C₁-C₄-alkyl and hydrogen.

28: The method according to claim 20, wherein at least one polymer (b-2) which is solid at room temperature and contains carboxylate groups and/or carboxylic ester groups is a copolymer which is obtainable by copolymerization of
(C) ethylene,
(d-1) at least one ethylenically unsaturated carboxylic acid or at least one ethylenically unsaturated carboxylic ester,
(E) if appropriate, further comonomers.

29: A melamine foam piece produced from
(a) open-cell melamine foams having a density in the range from 5 to 500 kg/m³ and a mean pore diameter in the range from 1 μm to 1 mm or
(b) open-cell melamine foams having a density in the range from 5 to 500 kg/m³ and a mean pore diameter in the range from 1 μm to 1 mm, which have been treated
(b1) with an aqueous formulation of at least one compound (b-1) having at least one hemiaminal or aminal group per molecule or at least one copolymer which comprises, incorporated in the form of polymerized units, at least one comonomer containing OH groups or β-dicarbonyl groups or epoxide groups, or
(b2) with at least one polymer (b-2) which is solid at room temperature, contains carboxyl groups and/or carboxylic ester groups and has a molecular weight Mₙ in the range from 1000 to 1 000 000 g/mol,
the melamine foam pieces having an average diameter in the range from 1 to 3 mm (weight average).

30: The method of using a melamine foam piece according to claim 29 for cleaning surfaces.

31: A method for cleaning surfaces using melamine foam pieces according to claim 29, wherein the surfaces are treated with a composite comprising a flexible substrate and aminoplast foam pieces fixed thereon.

32: A composite comprising a flexible substrate and melamine foam pieces according to claim 29 fixed thereon.

33: The composite according to claim 32, wherein the flexible substrate is selected from fibrous substrates.

34: The composite according to claim 32, wherein melamine foam pieces are fixed in a 1 to 10 mm thick layer on the flexible substrate.

35: A process for the production of composites according to claim 32, wherein the flexible substrate is treated with a melamine foam piece formulation comprising melamine foam pieces and is then dried.

36: The process according to claim 35, wherein the melamine foam piece formulation additionally comprises at least one resin (α) or at least one polymer (β).

37: The process according to claim 35, wherein the flexible substrate is treated on only one side with a melamine foam piece formulation comprising melamine foam pieces.

38: A melamine foam piece formulation comprising melamine foam pieces according to claim 29 and at least one resin (α) or at least one polymer (β).
